(19) United States
(12) Patent Application Publication
(10) Pub. No.: US 2006/0086705 A1
(43) Pub. Date: Apr. 27, 2006

(54) Device and method for controlling an operation involving the laser beam welding, hardfacing or machining of a part

(75) Inventors: Philippe Alips, Armbouts Cappel (FR); Francois Dubrulle, Dunkerque (FR); Gabriel Vergniez, Boisdinghem (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Usinor, Puteaux (FR)

(21) Appl. No.: 10/526,021

(22) PCT Filed: Jul. 30, 2003
(86) PCT No.: PCT/FR03/02405

§ 371 Date: Sep. 7, 2005

(30) Foreign Application Priority Data
Aug. 27, 2002 (FR) 02/10607

(51) Int. Cl. B23K 26/14; B23K 26/20

(52) U.S. Cl. 219/121.84; 219/121.63

(57) ABSTRACT

A device used to control the quality of an operation involving laser beam welding, hardfacing, or machining of a part. The device includes at least one gas blow nozzle including an exhaust duct used to release a stream of the gas and at least one photo-sensitive sensor disposed behind the exhaust duct. A method controls an operation involving the laser welding, hardfacing, or machining of a part.

The invention relates to controlling the quality in laser-beam welding, resurfacing or machining.

The use of high-energy-density beams has developed particularly great development during the last two decades, especially in the field of welding of bare or coated metal sheets for automobile applications, by virtue of advantageous characteristics:
limited vaporization of the coating, imparting a better galvanic protection against corrosion,
very small deformations of assemblies,
great precision and high welding speed,
bead appearance not requiring finishing,
good deep-drawing stability and fatigue strength of joints.

Nevertheless, various defects, in particular porosity and alignment errors, may develop, because of inadequate preparation conditions (such as imperfectly abutted setup), instabilities of the weld pool and excessive spatter. In this regard, the welding of steel sheets provided with zinc-base coatings presents quite particular difficulties. It is therefore necessary to acquire high-performance systems for controlling the methods, since instabilities of the weld pool can lead to development of potential defects.

Such in-line control can be achieved by means of different physical variables: The use of a laser beam causes formation of a plasma resulting from its interaction with the shield gas and the metal vapors. To minimize the formation of this plasma, which reduces penetration, there is used a blowing system composed of a small-diameter nozzle offset longitudinally to the rear of the welding head, which makes it possible to direct a jet of neutral gas a few millimeters above the surface of the part.

Different optical sensors such as photodiodes that are sensitive in the ultraviolet and visible regions can be used advantageously to analyze the stability of this plasma, which stability reflects that of the welding operation.

In the same way, infrared photodetectors placed behind the beam in the displacement direction can be used to measure the intensity emitted by the molten metal. As a general rule, the infrared intensity is an expression of the quantity of heat transferred to the part. Thus increased penetration is expressed by an increase of infrared emission.

Nevertheless, it is difficult to use these different sensors in practice: effectively, the energy received is slight, because the signal decreases in inverse proportion to the square of distance from the source to the sensor. Two solutions are then possible:
either to use large-diameter optical sensors: but this solution has the disadvantage of leading to a low signal-to-noise ratio. Effectively, the light energy emitted by the capillary originates from a small solid angle, and other undesirable light signals are then captured by the optical components. In practice, it is then very difficult to detect the development of defects in the midst of very noisy signals.
or to position the sensor close to the weld zone: in this case, the periodic expulsions and condensed metal vapors can degrade the optical components of the sensors fairly rapidly. The local temperature elevation no longer allows the sensor to be placed very close to the molten metal. Palliative techniques have been proposed, based on blowing a lateral gas jet in front of the sensor to protect it, or even protection of the optical components by a consumable transparent plate, which must be changed regularly. These solutions are not satisfactory, however, either from the economic viewpoint or from the viewpoint of signal reliability.

The purpose of the present invention is to resolve the problems cited in the foregoing. It is aimed in particular at providing a control device with which light signals that are emitted by the laser-beam/material interaction and that correspond to the quality of welding, resurfacing or machining [can be received] with a high signal-to-noise ratio and precise positioning relative to the laser beam, the said device being required to have little sensitivity to the different forms of pollution during welding, resurfacing or machining, inherent to every industrial environment.

With these objectives in mind, the first object of the invention is a device for controlling the quality of an operation of laser-beam welding, resurfacing or machining of a part, comprising at least one gas-blowing nozzle equipped with a duct for ejection of a flow of the said gas, the said nozzle offset behind the laser beam in the direction of the operation and equipped with at least one photosensitive sensor disposed behind the said ejection duct in such a way that it can receive at least one light signal penetrating into the said ejection duct and emitted during the said operation of welding, resurfacing or machining.

According to a preferred embodiment of the invention, the gas-blowing nozzle comprises a duct placed in the extension of the ejection duct, and the photosensitive sensor is disposed in the said duct.

According to another preferred embodiment, the gas-blowing nozzle comprises a duct placed in the extension of the ejection duct and a lateral duct opening into the said duct, the photosensitive sensor being disposed in the lateral duct, and a reflecting plate is disposed at the junction of the duct and lateral duct in such a way as to deflect the light signal toward the photosensitive sensor.

This reflecting plate is preferably semitransparent.

The device according to the invention may advantageously have one or more of the following characteristics, alone or in combination:
at least one photosensitive sensor is sensitive to infrared radiation,
at least one photosensitive sensor is sensitive to ultraviolet radiation,
at least one photosensitive sensor is isolated from the gas flow by a leak-tight partition that is optically transparent at least in the range of sensitivity of this sensor,
the device comprises means for filtering and amplifying the output signal of the photosensitive sensor,
the device comprises means for recording the output signal of the photosensitive sensor.

A second object of the invention is a method for controlling an operation of laser-beam welding, resurfacing or machining of a part, wherein at least one light signal originating from the operation of welding, resurfacing or machining is received by means of the device according to the invention, the variation of this light signal as a function of time is compared with at least one reference signal obtained under conditions such that no unacceptable volume or surface defect is present on the part, and acceptance or rejection of the welded, resurfaced or machined part is decided by comparison of these two signals.

Finally, a third object of the invention is a method for controlling an operation of laser-beam welding, resurfacing or machining of a part, wherein at least one light signal originating from the said operation of welding, resurfacing or machining is received by means of the device according to the invention, the variation of the said light signal as a function of time is compared with at least one reference signal obtained under conditions such that no unacceptable volume or surface defect is present on the said part, and the welding, resurfacing or machining parameters are automatically controlled as a function of the comparison of the said at least two signals.

The device for controlling the quality of an operation of welding, resurfacing or machining designed according to the invention has a certain number of advantages: since the sensor is integrated into the interior of a gas-blowing device, which itself can be placed in the immediate proximity of the zone of beam/material interaction, the signal-to-noise ratio is high. Any perturbations that may occur in welding, resurfacing or machining will therefore be more easily observable. Furthermore, the fact that the sensor is located in the very interior of the gas-supplying device (the gas being, for example, a neutral gas) protects this sensor from any degradation.

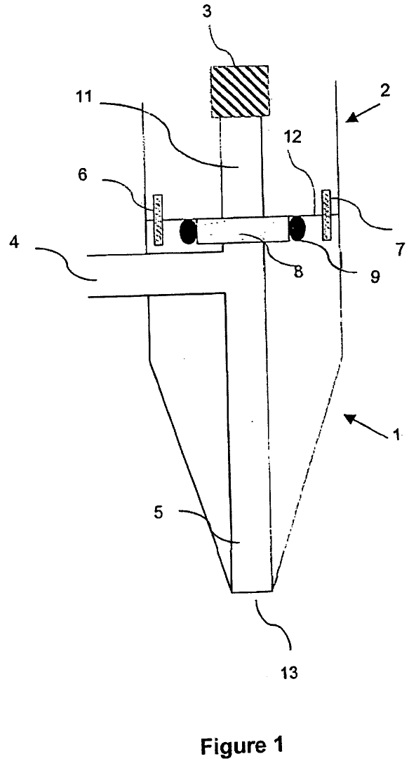

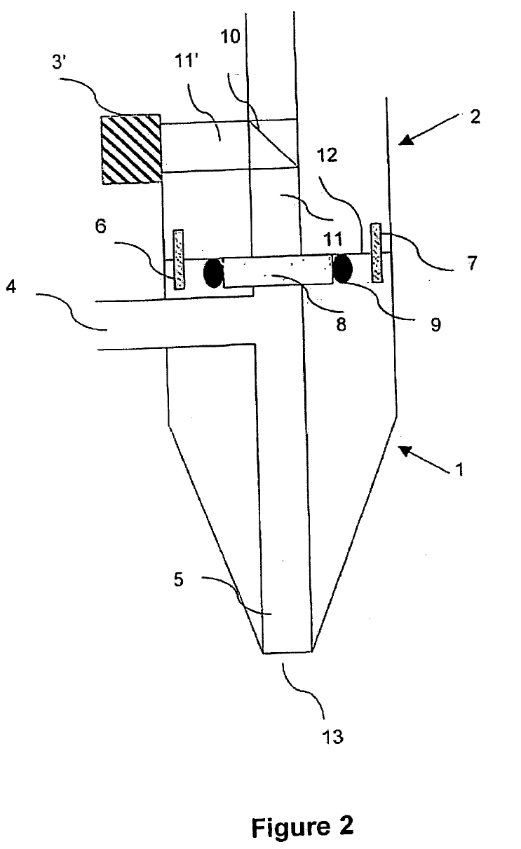

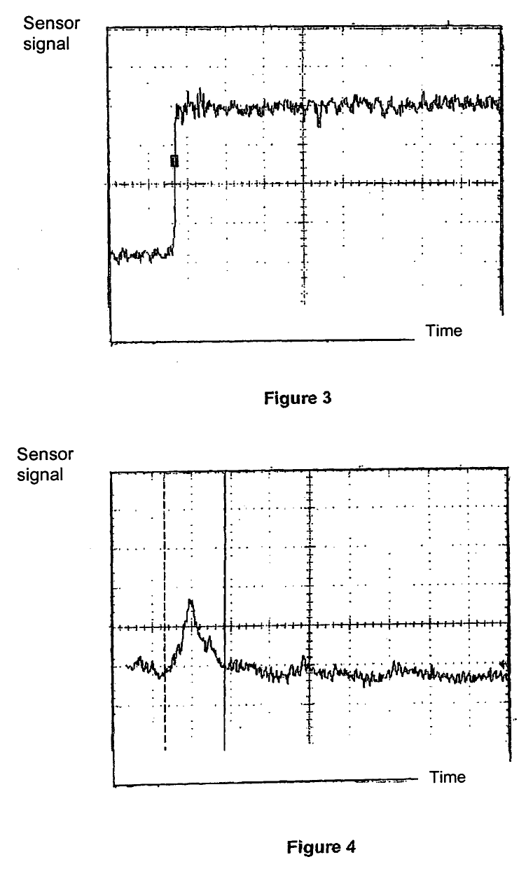

The invention will now be described in greater but non-limitative detail with reference to the attached figures, wherein:
FIG. 1 is a schematic view in section of a first embodiment of a device according to the invention,
FIG. 2 is a schematic view in section of a second embodiment of a device according to the invention,
FIGS. 3 to 5 illustrate examples of signals recorded during laser welding by means of a device according to the invention: they correspond respectively to a defect-free weld, to a weld in which an isolated defect has appeared or to a weld having numerous instabilities.

In the first embodiment illustrated in FIG. 1, the device for controlling the quality of an operation of laser-beam welding, resurfacing or machining of a part is composed of a gas-blowing nozzle 1 equipped with a measuring head 2 disposed on the rear face 12 of nozzle 1.

Nozzle 1 is provided with a gas-ejection duct 5 and a gas-supply duct 4 opening into duct 5. This latter duct 5, which is disposed in the axis of nozzle 1, opens on the one hand at front 13 of nozzle 1, on the side at which the gas flow is ejected from nozzle 1, and on the other hand at rear face 12 of nozzle 1.

Measuring head 2 is provided with a duct 11 opening at the front face of measuring head 2, intended to be attached to rear face 12 of nozzle 1, and with a photosensitive sensor 3 disposed in the axis of duct 11 and oriented to receive the light radiation entering via duct 5. The orientation of the sensor, coaxial with that of the course of the gas flow, guarantees that the zone observed thereby is indeed a zone of interaction with the gas.

Photosensitive sensor 3 is advantageously a detector of infrared radiation (such as a Ge photodiode+Si filter, an InGaAs photodiode) that records in particular the radiation originating from the molten zone, or a detector of ultraviolet radiation (such as a GaP photodiode, a silicon photodiode). The output signal of this photosensitive sensor can be advantageously filtered and amplified.

The front face of measuring head 2 is disposed against rear face 12 of nozzle 1 and maintained by centering means, such as centering pins 6 and 7, in such a way that duct 11 is coaxial with gas-ejection duct 5.

At the junction of the front face of measuring head 2 and rear face 12 of nozzle 1, duct 5 is separated from duct 11 by a partition 8, which is transparent to light rays at least in the range of sensitivity of sensor 3, and appropriate for the physical phenomenon to be measured. For example, in the case in which it is being endeavored to record the signal originating from the laser-welding plasma, there is advantageously used a partition that is optically transparent at least to ultraviolet radiation. This partition 8 rests on a seat machined in nozzle 1 or in measuring head 2. Partition 8 is advantageously supplemented by an O-ring 9 to ensure leak-tightness between nozzle 1 and measuring head 2.

According to a second embodiment illustrated in FIG. 2, the control device according to the invention is provided with a sensor 3′ disposed in a lateral duct 11′ and opening into duct 11. A reflecting plate 10, which may be semitransparent, is disposed at the junction of duct 11 and lateral duct 11′ in such a way that it deflects the radiation originating from ejection duct 5 and passing through duct 11, thus making it pass through duct 11′ in order to reach sensor 3′.

When it is wished to use the device according to the invention to control an operation of welding, resurfacing or machining, it is placed in such a way that front face 13 of nozzle 1 is oriented toward the plasma-formation zone or molten-metal zone, for example, and gas is blown.

In the case of laser welding, the nozzle may advantageously be that used to blow gas used to reduce plasma formation. The light radiation emitted during the operation of welding, resurfacing or machining penetrates axially into ejection duct 5, passes through partition 8 and continues its transit via duct 11. It is then received by photosensitive sensor 3 or 3′, which emits a signal used to measure the intensity of the radiation.

By virtue of one or more sensors, it is possible to record one or more light signals originating from the operation of welding, resurfacing or machining as a function of time. Preferably these sensors are positioned at a distance very close to the light source (plasma, molten metal), since the risks of damaging them by heat, spatter or metal vapors are reduced by virtue of their location in the interior of gas-blowing nozzles. In this way, the light signals received have great intensity. The variation of these light signals can then be compared with one or more reference signals obtained under conditions such that no volume or surface defect is present on the part. This comparison makes it possible to decide upon acceptance or rejection of the welded, resurfaced or machined part, or else to prevent the formation of defects by automatic control of the different welding parameters.

FIGS. 3 to 5 present examples of signals recorded by a device according to the invention during an operation of laser welding: electrogalvanized steel sheets of 1.2 mm thickness were welded by a 6-kW CO₂ laser at a speed of 1.5 m/min. The sensor is a silicon photodiode with sensitivity in a radiation range extending from 450 to 1100 nm, integrated into the interior of an argon-blowing nozzle placed behind the laser beam in welding direction. The nozzle is oriented toward the metal being melted by the laser beam. The distance between the point of incidence of the beam on the sheet and the end of the nozzle is 40 mm.

FIG. 3 illustrates a weld produced under satisfactory conditions: starting from the beginning of the welding operation (left part of the diagram), the signal recorded by the sensor and corresponding to the light energy returned by the molten metal does not exhibit any significant variation. In fact, examinations of the welds do not reveal any defect.

FIG. 4 shows a characteristic variation of the signal. This instability corresponds to the development of a defect at one point.

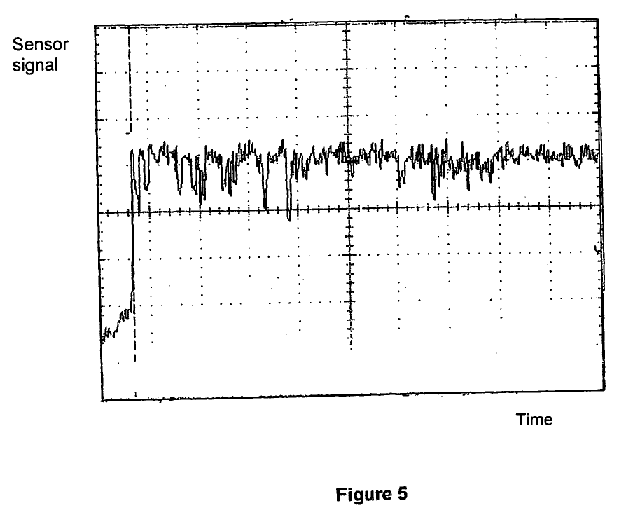

FIG. 5 corresponds to an operation of welding of a sheet having a zinc coating. The numerous signal perturbations recorded by the sensor according to the invention correspond to plasma instabilities and molten-metal spatter, and the weld contains large defects.

The inventive device, which can be placed at a short distance from the work zone during welding, machining or resurfacing, therefore makes it possible to record intense signals that are very characteristic of the quality of the assembly. The very compact and transportable device is easily inserted into the interior of a restricted space occupied by one or more welding or machining heads or by a plurality of gas nozzles, without affecting the efficient operation of the pre-existing components of a laser installation.

1-10. (canceled)

11. A device for controlling quality of an operation of laser-beam welding, resurfacing, or machining of a part, comprising:
at least one gas-blowing nozzle, the nozzle being offset behind a laser beam in a direction of operation,
the nozzle comprising a duct for ejection of a flow of the gas and equipped with at least one photosensitive sensor disposed behind the ejection duct to receive at least one light signal penetrating into the ejection duct in a direction opposite to the ejection of the gas flow and originating from interaction between the laser beam and a material of the part during the operation of welding, resurfacing, or machining.

12. A device according to claim 11, wherein said gas-blowing nozzle further comprises an extension duct placed in extension of the ejection duct, and wherein the photosensitive sensor is disposed in the extension duct.

13. A device according to claim 11, wherein the gas-blowing nozzle further comprises an extension duct placed in an extension of the ejection duct and a lateral duct opening into the extension duct, the photosensitive sensor being disposed in the lateral duct, and wherein a reflecting plate is disposed at a junction of the extension duct and lateral duct to deflect the light signal toward the photosensitive sensor.

14. A device according to claim 13, wherein the reflecting plate is semitransparent.

15. A device according to claim 11, wherein the photosensitive sensor is sensitive to infrared radiation.

16. A device according to claim 11, wherein the photosensitive sensor is sensitive to ultraviolet radiation.

17. A device according to claim 11, wherein the photosensitive sensor is isolated from the gas flow by a leak-tight partition that is optically transparent at least in a range of sensitivity of the photosensitive sensor.

18. A device according to claim 11, further comprising means for filtering, amplifying, and recording an output signal of the photosensitive sensor.

19. A method for controlling an operation of laser-beam welding, resurfacing, or machining of a part, wherein at least one light signal penetrating into the ejection duct in the direction opposite to the ejection of the gas flow and originating from the interaction between the laser beam and the material of the part during the operation of welding, resurfacing, or machining is received by a device according to claim 11,
wherein variation of the at least one light signal as a function of time is compared with at least one reference signal obtained under conditions such that no unacceptable volume or surface defect is present on the part, and
wherein acceptance or rejection of the welded or machined part is decided by comparison of the light signal measured during the operation of welding, resurfacing, or machining and the reference signal.

20. A method for controlling an operation of laser-beam welding, resurfacing, or machining of a part, wherein at least one light signal penetrating into the ejection duct in the direction opposite to the ejection of the gas flow and originating from the interaction between the laser beam and the material of the part during the operation of welding, resurfacing, or machining is received by a device according to claim 11,
wherein variation of the at least one light signal as a function of time is compared with at least one reference signal obtained under conditions such that no unacceptable volume or surface defect is present on the part, and
wherein the welding, resurfacing, or machining parameters are automatically controlled as a function of the comparison of the at least two signals.
